(19) United States
(12) Patent Application Publication
(10) Pub. No.: US 2023/0102491 A1
(43) Pub. Date: Mar. 30, 2023

(54) DYNAMIC FINANCIAL MANAGEMENT SYSTEM, METHOD AND DEVICE HAVING AN INTEGRATED ADVERTISEMENT FUNCTION

(71) Applicant: Paymation, Inc., Idyllwild, CA (US)

(72) Inventors: Khellar Sean Crawford, Idyllwild, CA (US); Sufi Sidhu, Irvine, CA (US); Carlos Cesar Reyes, North Hills, CA (US); Robert E. Danielson, San Rafael, CA (US)

(21) Appl. No.: 17/487,413

(22) Filed: Sep. 28, 2021

(51) Int. Cl. G06Q 30/02; G06Q 40/02

(52) U.S. Cl. CPC G06Q 30/0256; G06Q 30/0271; G06Q 30/0277; G06Q 40/02

(57) ABSTRACT

A dynamic personalizable automated finance management system that provides a financial management platform that enables users to easily generate a plurality of customized rules or conditions associated with one or more accounts thereby creating account plans that intelligently and passively execute the transfer of funds among accounts. The rules with a plan are able to define if, how much, when and where to transfer money to and from the accounts based on user entered criteria or triggers upon which the rules/conditions are based.

### FIELD OF THE INVENTION

The present invention relates to the field of financial management. Specifically, the present invention relates to a personalized dynamic financial management system, method and device.

### BACKGROUND OF THE INVENTION

Currently, all automatic savings or bill payment systems are limited to “dumb” payments that are for fixed amounts and are unable to adjust based on differing financial or other conditions. In particular, none of these systems allow users to easily automate rule based payments that cause transfers to behave dynamically according to evaluations of fluctuating variables such as balances, income, and other factors. As a result, users who desire more intricate control and/or are financially unable to rigidly save or make payments according to unchanging schedules and static amounts are unable to setup automatic finance management that meets their needs.

### SUMMARY OF THE INVENTION

A dynamic personalizable automated finance management system provides a financial management platform that enables users to easily generate a plurality of customized rules or conditions associated with one or more accounts thereby creating account plans. In particular, the rules are able to define if, how much, when and where to transfer money to and from the accounts based on user entered criteria or triggers upon which the rules/conditions are based.

A first aspect is directed to a method of dynamic financial management of one or more of monetary accounts. The method comprises receiving, at a financial management server, selection by a user of one or more goal parameters of a goal, the goal parameters including at least one of an item identifier and an activity identifier and selecting a set of advertisement content based on the at least one of the item identifier and the activity identifier with the financial management server, receiving, at the financial management server, selection by the user of one of the monetary accounts as a source account for an account rule corresponding to the goal and selection of another of the monetary accounts as a destination account for the account rule, receiving, at the financial management server, selection by the user of a primary condition of the account rule, the primary condition comprising a primary transfer amount metric including at least one of a static value and a percentage, wherein the metric defines a primary quantity of money from the source account that is to be transferred to the destination account if the primary condition is met, generating the account rule based on the source account, the destination account and the primary condition and resenting on a user device, with the financial management server, status information about the account rule corresponding to the goal in conjunction with the set of advertisement content selected based on the goal parameters.

In some embodiments, the method further comprises providing a graphical user interface, with the financial management server, wherein the graphical user interface enables the user to identify the one or more goal parameters by manually entering text into a text receiving feature of the graphical user interface. In some embodiments, the selecting the set of advertisement content comprises parsing one or more words from the text and comparing the parsed words to words associated with ads of a database of ads including the set of advertisement content. In some embodiments, the method further comprises providing a graphical user interface, with the financial management server, wherein the graphical user interface enables the user to identify the one or more goal parameters by selecting the at least one of the item identifier and the activity identifier from a list of a plurality of predetermined item identifiers and activity identifiers. In some embodiments, the method further comprises providing a graphical user interface, with the financial management server, wherein the graphical user interface enables the user to identify the one or more goal parameters by inputting a web address to a web page including the item identified by the item identifier.

In some embodiments, the monetary accounts are associated with a user account of the user, further comprising selecting, with the financial management server, at least a portion of the set of advertisement content based on at least one of: one or more types of one or more of the monetary accounts and identities of one or more entities associated with the one or more of the monetary accounts. In some embodiments, the method further comprises providing, with the financial management server, a rule following function that enables the user to select another account rule of another user and receive notifications indicating changes in status of the another account rule, wherein the another account rule corresponds to another goal of the another user having other goal parameters and selecting, with the financial management server, at least a portion of the set of advertisement content based on the other goal parameters of the another goal corresponding to the another account rule of the other user.

In some embodiments, the method further comprises providing, with the financial management server, a rule contribution function that enables the user to select another account rule of another user, wherein the another account rule corresponds to another goal of the another user having other goal parameters, automatically generating, with the financial management server, a contribution rule for the user, the contribution rule having a same destination account as the selected another account rule such that the user is able to contribute to the another account rule and selecting, with the financial management server, at least a portion of the set of advertisement content based on the other goal parameters of the another goal corresponding to the another account rule of the other user. In some embodiments, the advertisement content comprises hyperlinks to network accessible locations associated with the advertisement content.

A second aspect is directed to a dynamic financial management server for the management of one or more of monetary accounts. The server comprises a processor and a non-transitory computer-readable medium storing a financial management product and communicatively coupled with the servers over one or more networks, wherein when executed by the processor the financial management product is operable to receive selection by a user of one or more goal parameters of a goal, the goal parameters including at least one of an item identifier and an activity identifier and select a set of advertisement content based on the at least one of the item identifier and the activity identifier, receive selection by the user of one of the monetary accounts as a source account for an account rule corresponding to the goal and selection of another of the monetary accounts as a destination account for the account rule, receive selection by the user of a primary condition of the account rule, the primary condition comprising a primary transfer amount metric including at least one of a static value and a percentage, wherein the metric defines a primary quantity of money from the source account that is to be transferred to the destination account if the primary condition is met and store the account rule on the non-transitory computer-readable medium, wherein the account rule is based on the source account, the destination account and the primary condition and present status information about the account rule corresponding to the goal in conjunction with the set of advertisement content selected based on the goal parameters.

In some embodiments, when executed by the processor the financial management product is operable to provide a graphical user interface, wherein the graphical user interface enables the user to identify the one or more goal parameters by manually entering text into a text receiving feature of the graphical user interface. In some embodiments, the selecting the set of advertisement content comprises parsing one or more words from the text and comparing the parsed words to words associated with ads of a database of ads including the set of advertisement content. In some embodiments, when executed by the processor the financial management product is operable to provide a graphical user interface, wherein the graphical user interface enables the user to identify the one or more goal parameters by selecting the at least one of the item identifier and the activity identifier from a list of a plurality of predetermined item identifiers and activity identifiers. In some embodiments, when executed by the processor the financial management product is operable to provide a graphical user interface, wherein the graphical user interface enables the user to identify the one or more goal parameters by inputting a web address to a web page including the item identified by the item identifier.

In some embodiments, the monetary accounts are associated with a user account of the user and when executed by the processor the financial management product is operable to select at least a portion of the set of advertisement content based on at least one of: one or more types of one or more of the monetary accounts and identities of one or more entities associated with the one or more of the monetary accounts. In some embodiments, when executed by the processor the financial management product is operable to provide a rule following function that enables the user to select another account rule of another user and receive notifications indicating changes in status of the another account rule, wherein the another account rule corresponds to another goal of the another user having other goal parameters and select at least a portion of the set of advertisement content based on the other goal parameters of the another goal corresponding to the another account rule of the other user.

In some embodiments, when executed by the processor the financial management product is operable to provide a rule contribution function that enables the user to select another account rule of another user, wherein the another account rule corresponds to another goal of the another user having other goal parameters, automatically generate a contribution rule for the user, the contribution rule having a same destination account as the selected another account rule such that the user is able to contribute to the another account rule and select at least a portion of the set of advertisement content based on the other goal parameters of the another goal corresponding to the another account rule of the other user. In some embodiments, the advertisement content comprises hyperlinks to network accessible locations associated with the advertisement content.

A third aspect is directed to a non-transitory computer-readable medium storing a dynamic financial management product for providing dynamic financial management of one or more monetary accounts, wherein when executed by a processor the product performs a method. The method comprises receiving, via a user interface of the product, selection by a user of one or more goal parameters of a goal, the goal parameters including at least one of an item identifier and an activity identifier and selecting a set of advertisement content based on the at least one of the item identifier and the activity identifier with the product, receiving, via the user interface of the product, selection by the user of one of the monetary accounts as a source account for an account rule corresponding to the goal and selection of another of the monetary accounts as a destination account for the account rule, receiving, via the user interface of the product, selection by the user of a primary condition of the account rule, the primary condition comprising a primary transfer amount metric including at least one of a static value and a percentage, wherein the metric defines a primary quantity of money from the source account that is to be transferred to the destination account if the primary condition is met, generating the account rule based on the source account, the destination account and the primary condition and presenting on a user device, via the user interface of the product, status information about the account rule corresponding to the goal in conjunction with the set of advertisement content selected based on the goal parameters.

In some embodiments, the method further comprises enabling the user to identify the one or more goal parameters by manually entering text into a text receiving feature of the user interface. In some embodiments, selecting the set of advertisement content comprises parsing one or more words from the text and comparing the parsed words to words associated with ads of a database of ads including the set of advertisement content. In some embodiments, the method further comprises enabling, via the user interface of the product, the user to identify the one or more goal parameters by selecting the at least one of the item identifier and the activity identifier from a list of a plurality of predetermined item identifiers and activity identifiers. In some embodiments, the method further comprises enabling, via the user interface of the product, the user to identify the one or more goal parameters by inputting a web address to a web page including the item identified by the item identifier.

In some embodiments, the monetary accounts are associated with a user account of the user, further comprising selecting, with the product, at least a portion of the set of advertisement content based on at least one of: one or more types of one or more of the monetary accounts and identities of one or more entities associated with the one or more of the monetary accounts. In some embodiments, the method further comprises providing, with the product, a rule following function that enables the user to select another account rule of another user and receive notifications indicating changes in status of the another account rule, wherein the another account rule corresponds to another goal of the another user having other goal parameters and selecting, with the product, at least a portion of the set of advertisement content based on the other goal parameters of the another goal corresponding to the another account rule of the other user.

In some embodiments, the method further comprises providing, with the product, a rule contribution function that enables the user to select another account rule of another user, wherein the another account rule corresponds to another goal of the another user having other goal parameters, automatically generating, with the product, a contribution rule for the user, the contribution rule having a same destination account as the selected another account rule such that the user is able to contribute to the another account rule and selecting, with the product, at least a portion of the set of advertisement content based on the other goal parameters of the another goal corresponding to the another account rule of the other user. In some embodiments, the advertisement content comprises hyperlinks to network accessible locations associated with the advertisement content.

A fourth aspect is directed to a financial management device for the management of one or more of monetary accounts. The device comprises a processor and a non-transitory computer-readable medium storing a dynamic financial management product, wherein when executed by the processor the product performs a method comprising receiving, via a user interface of the product, selection by a user of one or more goal parameters of a goal, the goal parameters including at least one of an item identifier and an activity identifier and selecting a set of advertisement content based on the at least one of the item identifier and the activity identifier with the product, receiving, via the user interface of the product, selection by the user of one of the monetary accounts as a source account for an account rule corresponding to the goal and selection of another of the monetary accounts as a destination account for the account rule, receiving, via the user interface of the product, selection by the user of a primary condition of the account rule, the primary condition comprising a primary transfer amount metric including at least one of a static value and a percentage, wherein the metric defines a primary quantity of money from the source account that is to be transferred to the destination account if the primary condition is met, generating the account rule based on the source account, the destination account and the primary condition and presenting on the device, via the user interface of the product, status information about the account rule corresponding to the goal in conjunction with the set of advertisement content selected based on the goal parameters.

In some embodiments, when executed by the processor the product enables the user to identify the one or more goal parameters by manually entering text into a text receiving feature of the user interface. In some embodiments, selecting the set of advertisement content comprises parsing one or more words from the text and comparing the parsed words to words associated with ads of a database of ads including the set of advertisement content. In some embodiments, when executed by the processor the product enables, via the user interface of the product, the user to identify the one or more goal parameters by selecting the at least one of the item identifier and the activity identifier from a list of a plurality of predetermined item identifiers and activity identifiers. In some embodiments, when executed by the processor the product enables, via the user interface of the product, the user to identify the one or more goal parameters by inputting a web address to a web page including the item identified by the item identifier.

In some embodiments, the monetary accounts are associated with a user account of the user and when executed by the processor the product selects at least a portion of the set of advertisement content based on at least one of: one or more types of one or more of the monetary accounts and identities of one or more entities associated with the one or more of the monetary accounts. In some embodiments, when executed by the processor the product provides a rule following function that enables the user to select another account rule of another user and receive notifications indicating changes in status of the another account rule, wherein the another account rule corresponds to another goal of the another user having other goal parameters and selects at least a portion of the set of advertisement content based on the other goal parameters of the another goal corresponding to the another account rule of the other user. In some embodiments, when executed by the processor the product provides a rule contribution function that enables the user to select another account rule of another user, wherein the another account rule corresponds to another goal of the another user having other goal parameters, automatically generates a contribution rule for the user, the contribution rule having a same destination account as the selected another account rule such that the user is able to contribute to the another account rule and selects at least a portion of the set of advertisement content based on the other goal parameters of the another goal corresponding to the another account rule of the other user. In some embodiments, the advertisement content comprises hyperlinks to network accessible locations associated with the advertisement content.

### BRIEF DESCRIPTION OF THE DRAWINGS

FIG. 1A illustrates a dynamic personalizable automated finance management system (AFM) system for providing features of an AFM product according to some embodiments.

FIG. 1B illustrates an exemplary more detailed view of the AFM system according to some embodiments.

FIG. 2 illustrates a block diagram of an exemplary computing device according to some embodiments.

FIG. 3 illustrates a method of dynamic financial management of one or more of monetary accounts according to some embodiments.

FIG. 4 illustrates of method of dynamic financial management of monetary accounts including an integrated advertisement function according to some embodiments.

### DETAILED DESCRIPTION OF THE INVENTION

The dynamic personalizable automated finance management system (AFM) described herein provides a financial management platform that allows users to easily generate a plurality of customized rules having conditions associated with one or more accounts thereby creating account plans (each plan having one or more rules and each rule having one or more conditions). In particular, the conditions/rules/plans are able to define how much, when and where to transfer money to and from the accounts based on user entered criteria or triggers upon which the conditions of the rules/plans are based. In other words, the AFM gives a user the ability to schedule the payment of bills or the movement of money among different accounts depending on the status and activity of his/her accounts and/or related conditions. As a result, the AFM enables individuals to personalize the actions of their accounts beyond mere savings or bill payment to automatically and dynamically adjust to different personal financial situations or preferences. Accordingly, the AFM provides the advantage of allowing users to move money according to various scheduled rules, thus allowing users at large to fully control their moneys, incomes, and payments based on highly customizable rules. For example if a user schedules a payment for a future date, he/she are able to set up a rule to skip the payment if his/her funding source account (account from which the user's own funds are taken) has a low balance, or increase the payment if his/her funding account balance is unusually high. Therefore, at a time when a transfer is scheduled to be executed (as determined by an entered frequency or an event such as a deposit made to an account and/or the clearance thereof), all of the user's custom settings and rules are evaluated uniquely against all present related conditions to determine what dollar amount should be transferred, when it should be transferred and where it should be transferred to/from.

Thus, the AFM is able to be used to set up a fluctuating savings plan for a freelancer with highly variable income patterns, create a specific revenue—split for business partners from one main account to multiple others, set up a dedicated “save and purchase plan” for an item from an online retailer, automatically pay bills as long as they are not unusually high and there exists at least a certain balance in the user's funding account, or passively repay debt among friends or family members. Further, the AFM provides a smart way to conditionally direct income, payments, or savings automatically, mainly in response to fluctuations in the balance and cash—flow of a user's funding source account, but also possibly in response to many other measurable or readable conditions. Accordingly, the AFM provides users with a reliable, passive solution for automatically sending, receiving, and moving different amounts of money according to fluctuations in the users' incomes, account balances, or other digitally available variables from publicly accessible data such as stock prices or prices of products online to private data read through 3rd party application program interfaces. In other words, the AFM is able to provide users with more control over the automation of their cash flow and purchases by incorporating scheduling with programmatic conditional rules which evaluate available data and hence determine resultant financial actions.

### AFM System

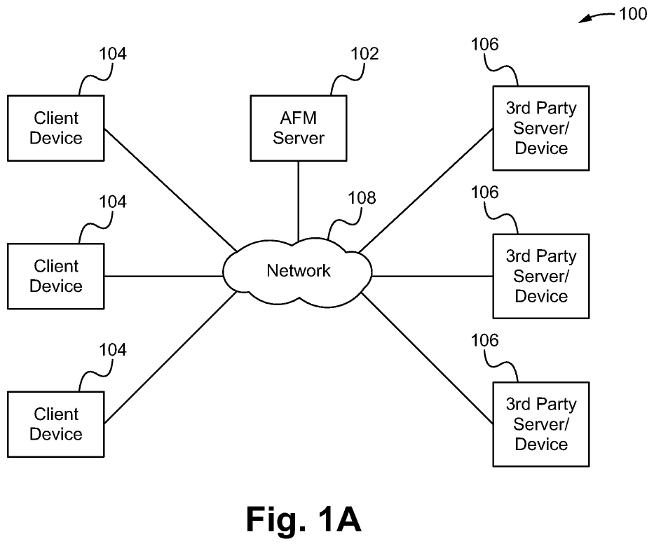

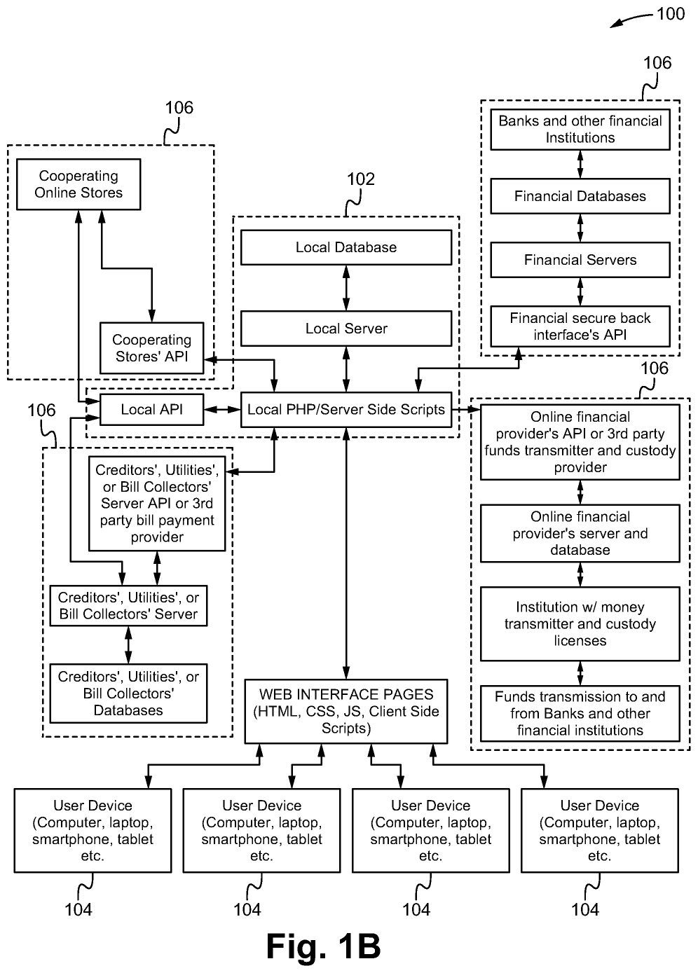

FIG. 1A illustrates an AFM system 100 for providing features of an AFM product according to some embodiments. Similarly, FIG. 1B illustrates an exemplary more detailed view of the AFM system 100 according to some embodiments As shown in FIGS. 1A and 1B, the system 100 comprises one or more AFM servers 102, one or more client devices 104 and one or more third party servers/devices 106 all coupled together over one or more networks 108. The networks 108 are able to be one or a combination of wired or wireless networks as are well known in the art. The one or more servers 102 are able to store, maintain and/or operate the AFM product for providing the dynamic financial management features of the AFM as described below. In some embodiments, the entirety of the AFM product and its features is able to be provided by the servers 102, for example, in the form of one or more websites operated by the servers 102. Alternatively, a user is able to download some or all of the product from the servers 102 onto one of the client devices 104, wherein the product is in the form of a program or application that is able to execute locally on the client device 104 and provides some or all of the AFM product features.

Alternatively, the product is able to be in the form of a widget that operates on one or a plurality of server and/or websites (e.g. to provide added functionality to a bank website). In particular, in such embodiments the downloaded application, widget and/or the servers 102 together are able to provide all of the features of the AFM product by communicating via the network 108. In other words, together and/or separately the features of the AFM product are able to be provided by one or more widgets operating on other website/servers, one or more websites on the servers 102 and/or a local AFM application on the client devices 102. Alternatively, the application and/or widget is able to provide all of the features of the product without the servers 102. Accordingly, although described herein as a downloadable application for the sake of brevity, it is understood that the described features are able to be provided by the other platforms described above.

After being downloaded to the client device 104, the application is able to use the local memory on the device 104 to store and utilize data necessary for operation of the application in an application database on the device 104. Alternatively, some or all of the data for operating the application is able to be stored in a server database on the servers 102 such that the application must connect to the servers 102 over the networks 108 in order to utilize the data on the server database. For example, the locally executing application is able to remotely communicate with the servers 102 over the network 108 to perform any features of the application and/or access any data on the server database not available with just the data on the application database. In some embodiments, the same data is stored on both the server database and the application database such that either local or remote data access is possible. In such embodiments, the databases are able to be periodically synchronized over the network 108. Although as shown in FIG. 1A one AFM server 102 is coupled with three client devices 104 and three 3^{rd} party servers/devices 106, it is understood that the system 100 is able to comprise any number of servers 102, devices 104 and/or servers/devices 106 coupled together via the network 108. Additionally, it should be noted that, for the sake of brevity, the following discussion relates to the functions and operation of application, the application user interface and the application database, however it is understood that the discussion is able to also relate to the function and operation of the website, the website user interface and the server database, or both.

The third party servers 106 are able to comprise merchants, banks and other financial institutions, online financial providers, billing service providers, online gaming services, academic institutions, and/or other network-accessible software and/or hardware entities. Specifically, the third party servers 106 are able to be entities having data upon which rules are able to be based (e.g. account data, grade data, sports data), entities having items/services for purchase and data about those items/services, and/or entities having financial account data from which or with which money is able to be transferred. In some embodiments, the user interface of the AFM product (as provided by the website and/or application) is able to comprise a focused question by question guide presentation that enables users to easily schedule financial transactions which may change depending on user defined rules. Alternatively, other forms of interface presentations are able to be used that enable the generation of rules and other features of the product as described herein. Thus, the AFM interface provides the advantage of a streamlined process that breaks down each of the features of the product into a few easy steps.

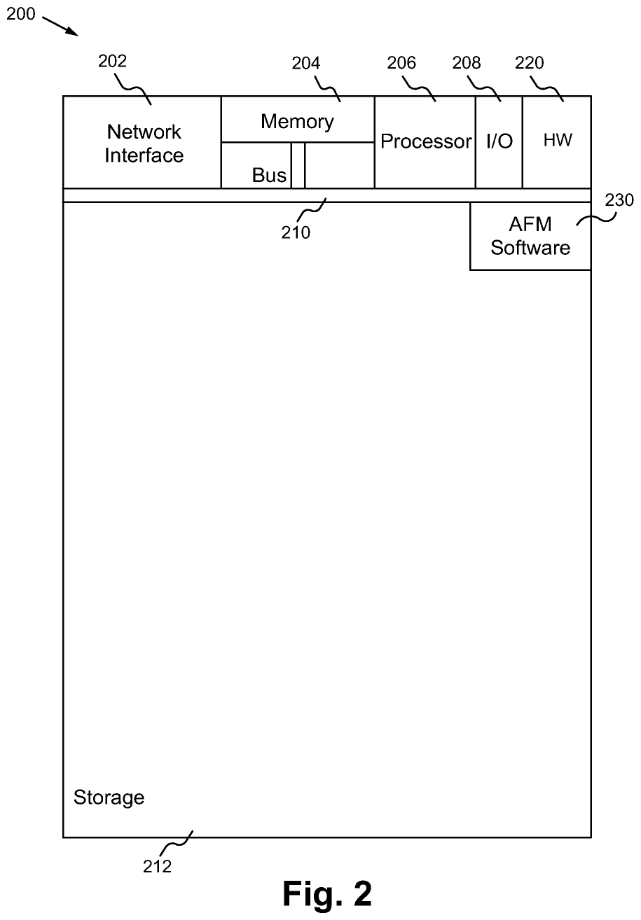

FIG. 2 illustrates a block diagram of an exemplary computing device 200 according to some embodiments. The computing device 200 is able to be one or more of the servers 102 and/or one or more of the devices 104. In general, a hardware structure suitable for implementing the computing device 200 includes a network interface 202, a memory 204, a processor 206, I/O device(s) 208, a bus 210 and a storage device 212. Alternatively, one or more of the illustrated components are able to be removed or substituted for other components well known in the art. The choice of processor is not critical as long as a suitable processor with sufficient speed is chosen. The memory 204 is able to be any conventional computer memory known in the art. The storage device 212 is able to include a hard drive, RAM, SRAM, CDROM, CDRW, DVD, DVDRW, flash memory card or any other storage device. The computing device 200 is able to include one or more network interfaces 202. An example of a network interface includes a network card connected to an Ethernet or other type of LAN. The I/O device(s) 208 are able to include one or more of the following: keyboard, mouse, monitor, display, printer, modem, touchscreen, button interface and other devices. The AFM software or module(s) 230 used to operate the application and/or website are likely to be stored in the storage device 212 and memory 204 and processed as applications are typically processed. More or less components shown in FIG. 2 are able to be included in the computing device 200. In some embodiments, AFM hardware 220 is included. Although the computing device 200 in FIG. 2 includes software 230 and hardware 220 for the AFM product, the features of the AFM product are able to be implemented on the computing device 200 in hardware, firmware, software or any combination thereof. Examples of suitable computing devices include a personal computer, a laptop computer, a computer workstation, a server, a datacenter, a mainframe computer, a handheld computer, a personal digital assistant, a cellular/mobile telephone, a smart appliance, a gaming console, a digital camera, a digital camcorder, a camera phone, an iPod®, a video player, a DVD writer/player, a Blu-ray® writer/player, a television, a home entertainment system or any other suitable computing device.

### AFM Product

The AFM product (as implemented by the application and/or website) is able to comprise a login and registration module, an account module, a rule/plan editing module, a rule generation module, a group identification module, a token generation module, a social module, a notification module, a rule prioritization module, a review module, an account grouping module, a product purchase module, a virtual savings bin module and an integrated advertisement module, wherein the product and/or graphical user interface is configured to enable users to utilize the modules.

### The Login and Registration Module

The login and registration module enables a user to create a user profile by inputting username and password information via the graphical user interface that is then associated with the profile such that the information is able to be used to identify the user when logging onto the application. Alternatively, the login information is able to be omitted and a user is able to use the application without creating a user profile or logging in. In such embodiments, the application on each client device 104 is able to have single a unique profile or identifier that is able to be identified by the server 102 and/or AFM product. After a user profile is created, the user is able to access the profile and any associated data by entering the username and password in order to identify themselves to the application. In some embodiments, 2-factor identity verification may be required, wherein a second tier of validation must be satisfied, such as the automatic transmission via SMS of a temporary password to a user's mobile device which must be entered in order to access the profile.

### The Account Module

The account module enables a user to add one or more accounts to the associated user profile, add or move money between the accounts and withdraw money from the accounts. For example, in order to add an account the module enables a user to enter a routing number and an account number of the account which they would like to associated with the user profile. The user is then able to be prompted for a username and password (or another method of verification) to automatically verify the bank account. Further, if adding a credit card, the user is able to enter the card number, expiration date, and security code, wherein if further verification is required by the credit card issuer, steps will be taken as advised by the card provider. Moreover, if adding an online payment system account (e.g. PayPal®), the module is able to ask and input a username and password associated with the online payment system to link the account. In this manner, the account module enables the user to save the added account and/or add additional accounts. The account module further enables money to be added/transferred/withdrawn between the accounts. For example, the user is able to select one of the accounts associated with the user profile, enters an amount to be added to or withdrawn from another account and confirms the deposit. In some embodiments, the user is able to enter a nickname for the deposit transaction.

### The Rule Generation Module

The rule generation module enables users to generate a rule/plan for one or more accounts (and/or combined accounts as described below) that dynamically transfer money into and/or out of the accounts. Each rule comprises a duration, one or more condition-trigger pairs, an interval/frequency, and one or more actions. As a result, the rules/plans are able to automatically perform designated actions (e.g. transfer money) to manage the accounts of a user profile according to the scenarios defined by the condition-trigger pairs of the rules/plans. For example, a user is able to use the rule generation module to generate an auto bill pay rule/plan associated with an account with two condition pairs. One condition pair to automatically pay a bill if it is under $200 (e.g. condition 1: trigger=bill amount, condition=less than or equal to $200, action=pay bill), and another condition pair to hold the payment, notify the user, and let him/her decide what to do next if the bill is over $200 (e.g. condition 2: trigger=bill amount, condition=greater than $200, action=notify and wait for confirmation). Alternatively, the second/another condition pair is able to be an exception to the first condition such that the first condition is not performed if the second/exception condition is met. For example, the second condition is able to hold the payment, notify the user, and let him/her decide what to do next if the balance of the auto bill pay source account is below $200 (e.g. condition 2: trigger=source account balance, condition=less than $200, action=notify and wait for confirmation). Thus, in the first scenario the bill is not paid (without confirmation) if it is over the expected amount, and in the second scenario, the bill is not paid without confirmation (even if it is lower than $200) if the source account balance is below $200. Auto bill pay rule generation selection boxes are able to be added to the rule generation interface as an easier way to add the “funding account must have at least” and/or the “bill amount must be less than” conditions to any of the rules (as either a primary or exception condition). Indeed, any number of types and combinations of conditions described herein are able to be utilized to customize the auto bill pay. Consequently, using one or a plurality of these types of rules/plans for one or more of a user's accounts, the user is able to customize the AFM product such that is automatically financially manages the user's money as desired.

The duration of each rule defines when implementation of the rule by the product (e.g. implementation module) is to begin and end. For example, the duration is able to be a defined range of dates such as Jan. 1, 2012 to Mar. 3, 2012 or an undefined range of dates (e.g. with no defined end date) such Jan. 1, 2012 to manual termination by the user. In some embodiments, the duration is able to be seasonal or annual by defining the range of dates such as January 1^{st}, to March 3^{rd}, whereby not specifying a start and end year, the plan is able to persist from year to year and be evaluated as valid as long as the date of execution of the rule is after the first date and before the second date of the same year, or of the following year in cases when the first date is a month that occurs sequentially later in a year such as October 1^{st} to February 3^{rd}. Alternatively, the end and/or start of the duration is able to be based on a starting and/or ending trigger. For example, the end is able to be when a predetermined amount of money transferred by the rule reaches a desired value (e.g. goal amount). In particular, the end and/or start triggers are able to be any one or combination of the triggers of the condition-trigger pairs as described below wherein the start or termination of performance of the rule by the performance module occurs based on the end/start triggers occurring.

The condition-trigger pairs define a trigger or monitored variable (e.g. parameter, criteria) upon which the control of the accounts (for which the plan/rules are created) is based and an associated condition of a value or range of values that the trigger must match in order for an action associated with the pair to be performed. For example, if the value of a trigger matches an acceptable value of the paired condition, the condition is met and the associated action is able to be performed (assuming any other conditions associated with the action have also been met). In some embodiments, each rule is able to have a “primary” condition-trigger pair and one or more “exception” condition-trigger pairs, wherein the primary pair is executed when none of the exception conditions are satisfied. In such embodiments, the condition of this primary pair is the value or values indicated by the interval/frequency of the rule as when the rule is to be evaluated (e.g. every Monday) and the trigger of the primary pair is the interval/frequency parameter (e.g. the day of the week) such that the primary condition-trigger pair is met whenever the interval/frequency is met. As a result, the action associated with the primary pair is executed (pending satisfaction of user confirmation requirements, if any) at each interval when the rule is evaluated unless at least one of conditions of the exception pairs is met (in which case the action of the at least one of the conditions of the exception pairs is executed (again pending satisfaction of user confirmation requirements).

In some embodiments, each of the triggers is one of the group comprising: an account balance (e.g. source account, destination account, third party account, local account or combination thereof), a balance change (e.g. income) of an account (source and/or destination account), a balance change (having a value within a specific range, from a specific source, of a specific type and/or during a specific time period) of an account (source and/or destination account), a current date or time (e.g. day, month, year), a price of an item/service (including or excluding taxes, shipping costs, discounts/sales and/or other fees), bill due date, total amount owed (e.g. billed amount plus remaining debt), minimum payment due on bill, a current amount billed (e.g. billed amount), letter/number grade, grade point average, event outcome (e.g. sports event, spread, point totals), other network accessible data values or combinations thereof. For example, a trigger is able to be check deposits or debits, direct/auto deposit deposits, the clearing of check deposits or debits, the clearing of direct/auto deposit deposits, deposits or debits having a value within a desired range (e.g. greater than $100), deposits/debits within last month, the sum of deposits/debits within the last month having a value within a selected range, deposits/debits from one or more designated third party accounts, and/or check deposits within last month within a specified value range from a designated third party account. In other words, any data that is able to be monitored or accessed over a network (e.g. the internet) is able to be used as a trigger.

Similarly, the conditions are each able to comprise one or a set of values that the trigger is able to be that satisfy the condition. Thus, the conditions are able to be a numerical range or single value (e.g. 1-100), a dynamic numerical range or single value (e.g. between 10 and 15% of total balance of account), a dynamic or static non-numerical value (e.g. letter grade A, a letter grade above previous letter grade), an event/outcome (e.g. Celtics beat Lakers) or a combination thereof. In other words, the conditions are able to comprise any value or set of values that the paired triggers can be.

Additionally, each of the condition-trigger pairs is associated with one or more of the actions such that if the pair is satisfied the one or more of the actions are able to be performed. Further, a plurality of pairs are able to be associated with the same one or more actions such that the action is only performed if all of the associated pairs have been satisfied. For example, a first pair associated with the action of a transfer of $100 to a savings account is able to require an account balance of over $500 and a second pair associated with the same action is able to require a most recent deposit of greater than $1000. Thus, the action of transferring the $100 dollars will only occur when both of the pairs have been satisfied, wherein an action or set of actions are able to be associated with any number of a plurality of pairs. In some embodiments, the pairs of each rule/plan are mutually exclusive such that only one of the pairs is able to be satisfied at once (and therefore only one of the associated actions is performed at once). Alternatively, one or more of the pairs of each rule/plan are able to be satisfied simultaneously or concurrently such that the associated actions are all performed. Indeed, as described above, when one of the actions is associated with a plurality of pairs, by definition, all of the plurality of the pairs all need to be satisfied simultaneously or concurrently for the action to be performed.

In some embodiments, each of the rules further comprise starting, ending and/or milestone condition pairs. In particular, these pairs are the same as the condition-trigger pairs except for the differences described herein. Specifically, the action for when the starting condition pair is satisfied is to start the implementation of the rule, the action for when the ending condition pair is satisfied is to terminate or pause the implementation of the rule, and the action for when the milestone condition pair is satisfied is a notification that a milestone has been reached (e.g. saved $1000) to specified users via specified message medium. As a result, the starting and/or ending pairs are able to be used by the implementation module to determine when to start or end implementation of the rule. For example, a starting condition pair is able to be “start when the account balance reaches $1000” and an ending condition pair is able to be “terminate when the account balance reaches $10000.” Alternatively, the ending condition is able to be omitted or indicate that the rule is to be performed indefinitely. And the notification module is activated when a milestone pair is satisfied to transmit the milestone message/notification. For example, a milestone condition pair is able to be “notify parents when grade point average is below to 2.0.” Alternatively, in some embodiments one or both of the starting and ending condition pairs are simply starting and/or ending dates, wherein the implementation module begins implementing the rule on the starting date and ends implementation (via termination or pausing) at the end date, wherein the difference between the terminate action and the pause action is that although both result in the rule no longer being actively implemented, the termination action also deletes (or categorizes as completed) the rule from the AFM system whereas the pause action saves the rule for future use/re-activation.

The interval (or time of evaluation) defines when and/or how frequently the pairs of the rule are evaluated to determine if the conditions are satisfied by the triggers and thus whether the associated actions should be taken. Thus, the interval is able to be a periodic time (e.g. weekly, monthly, every 10 days), a single time (e.g. Jan. 1, 2020), upon demand/command by a user or based on an interval condition pair. Specifically, the interval condition pair is able to be the same as the condition-trigger pairs except that the action for satisfaction of the interval condition pair is evaluate the rule and its condition-trigger pairs. For example, the interval condition pair is able to be “every time a deposit is made to a selected account” or “every time a deposit is received from a specific source in a selected account,” or any of the other possible triggers/conditions like the condition trigger-pairs. Thus, by selecting the interval, the user is able to refine when the rule is implemented.

As described above, the actions are each associated with one or more of the pairs described above wherein the actions are performed if all of the associated pairs have been satisfied. The actions are able to comprise a transfer of money (e.g. withdrawal or deposit between two or more accounts), a purchase of an item/service (based on the purchase module), information notification to a user of a status (e.g. transfer performed), confirmation notification to a user of a pending action (e.g. please confirm transfer should be performed), termination or pausing of a rule (e.g. for an ending pair), starting of a rule (e.g. for a starting pair), milestone notification (e.g. similar to information notification for milestone pair), or other actions known in the art. Additionally, the actions are able to be conditional or independent combinations of the above actions, wherein independent combinations of actions are all implemented independently when the pairs are met whereas conditional combinations require one or more of the actions of the combination to wait on the performance of one or more of the other actions of the combination (and/or other data) before performance. In other words, two or more actions are grouped such that the same one or more conditions being satisfied causes the entire group to be performed. For example, a condition combination of actions is able to be a confirmation message action and a money transfer action wherein the money transfer action does not occur unless the confirmation action has been performed and the user confirmed that the transfer should be sent/made. As another example, an independent combination is able to be a notification message action and a money transfer action wherein both the notification and the money transfer are performed independent of each other.

Further, each of the actions are able to have associated values and/or messages. For example, transfers are able to have an amount of money to transfer and notifications are able to have the data or text of the message to be conveyed, the medium to convey the message and the addresses or users to convey the message to. In particular, the transfer values, like the trigger values, are able to be static amounts (value), relative/dynamic amounts (5% of deposits in the last month) or a combination/hybrid amount ($400 plus 5% of the total balance of the account). Thus, the implementation module is able to use these action values to determine how much to transfer and/or what to “say” when performing transfer and/or notification actions.

Thus, the rule generation module enables users to select one or more of the actions, the triggers, the conditions (acceptable values and/or measurement metric/equation) and the interval via the user interface (e.g. selection from a list of a drop down box, entering text in a text box). Alternatively, one or more of the components of each of the rules are able to be determined automatically by the generation module with default values (e.g. if the user does not or cannot select a value). Once the necessary aspects of the rule/plan have been selected or assigned a default value, the generation module generates and stores the rule such that it is able to be implemented by the implementation module as described below.

For example, for a plan having an action of transferring money from a selected checking source account to a selected savings destination account based on a primary condition trigger pair (base transfer rule) and two exception condition trigger pairs (conditional rule 1 and conditional rule 2), the primary condition will pay a metric determined amount every interval/frequency of 1 month unless the first exception is met with the trigger of the payer's checking account balance meeting the condition of being less than $1000 or the second exception is met with the trigger of the payer's checking account balance meeting the condition of the balance being between $4000 and $10000. The primary condition transfer amount metric/equation is 10% of the checking account balance plus $100, the first exception condition transfer amount metric/equation is 5% of the checking account balance plus $0 and the second exception condition transfer amount metric/equation is 12% of the checking account balance plus $3000. Further, the rule/plan will last for the duration of from Feb. 14, 2014 to an indefinite end date (e.g. no end date; save without limit). Finally, the second exception condition requires a confirmation “(text confirmation is required)” before it is executed whereas the primary and first exception condition do not require confirmation before execution is performed.

### Group Identification Module

In some embodiments, the AFM comprises a group identification module that enables users to create more complex trigger-condition pairs for one or more rules/plans by allowing parameters/values of the pairs to be identified dynamically (e.g. a changing group) instead of statically. In particular, the module enables the sources/destinations of the trigger-condition pairs to be described by source/destination rules (e.g. that are determined at the time of execution of the plan/rule). Thus, instead of just selecting a static source or destination (e.g. a particular account) as a source/destination for a rule/condition-trigger pair (e.g. transfer X to account Y if account A has more than $200), a user is able to create a source/destination rule that defines the source or destination (e.g. transfer X to account Y with money from source group A if it is greater than $200, where source group A is defined by source rule A). For example, a rule/condition-trigger pair including a source/destination rule is able to be: transfer X to account Y with money from source group A if it is greater than $200, where source group A is defined by source rule A which is “all deposits in the last month from sources including the keywords: A and B or C.” Or another example would be: transfer X to destination group A if account Y has more than $200, where destination group A is defined by destination rule A, which is “accounts including the keywords: A and B or C.” Thus, instead of identifying one or more sources/destinations directly and statically, the module enables a user to identify them dynamically using a source/destination rule (where the sources/destinations that are identified by the rule can change over time as the characteristics of the sources/destinations change and the fall out of or move into the boundaries of the rule). Further, the source/destination rules are able to be used in combination with the static identification of one or more sources/destinations (e.g. to ensure that a source/destination is always included even if it falls out of the rule). For example, a source rule is able to be: $100 of account Z (i.e. a static source identifier) and “all deposits in the last month from sources including the keywords: A and B or C” (i.e. a dynamic rule source identifier) such that the source group will always include the statically identified source in addition to the dynamically changing sources that fall into the source rule. As a result, the group identification module of the AFM provides the benefit of enabling a user to define dynamic sources/destinations for use in rules.

The source/destination rules are able to be created by a user via the AFM user interface by manually entering queries, data sets to apply the queries to and/or valuation parameters as the dynamic data (and/or along with selecting static data from presented options (e.g. a list of accounts)). In particular, the queries are able to include identified characteristics (e.g. name, account number, owner) and operators (e.g. boolean operators) combined with keywords, strings or other types of queries (e.g. equal to keyword A). The data sets are able to include source or destination type identifiers (e.g. all accounts, all owned accounts, accounts created in the past year, savings accounts, or other types of accounts) and the valuation parameters are able to define how the money in the source is quantified (e.g. only money in time frame A, only money above threshold A, all money in account, only 10% of total money in account). Thus, a user is able to input as a new source rule 1) characteristic: name; operator: equal to; keywords A, B and C; data set: all owned accounts; and valuation parameters: deposits in the last month.

As a result, when determining the source/destination group for that new source/destination rule, the module applies the keywords A, B and C to the data set of all the owned accounts, and using the resulting accounts, it identifies the portion of the money in those accounts that satisfies the valuation parameter of deposited in the last month. That identified money in those identified accounts is what is defined by that new source rule at that time for the purposes of executing a plan/rule that includes that source rule. In some embodiments, during creation of a new source/destination rule the results (i.e. the accounts/valuation that would be defined by the rule at that time) are presented to the user such that the user is able to verify that the source/destination rule is adequate or further refine the query, parameter and/or data set to produce different results. In some embodiments, while the query terms are able to be entered in a search box, the query target characteristic, data set and/or valuation parameter are able to selected from one or more presented options (e.g. drop-down boxes presenting possible data sets and/or parameters for a user to select).

In some embodiments, instead of (or in addition to) manually entering data for a source/destination rule the user is able to select one or more elements from a selected/displayed data set (e.g. all debits in the last year), and the group identification module automatically creates a rule that defines the selected elements from the data set (at that time). For example, upon selecting elements (e.g. deposits) A, B and C from a data set of A-Z, the module automatically generates a query that when applied to the data set returns only elements similar to A, B and C. Similarly, the module enables a user to select one or more of the elements of the data set for exclusion from the rule. For example, upon selecting elements (e.g. deposits) A, B and C for inclusion and element D for exclusion from a data set of A-Z, the module generates a query that when applied to the data set returns only elements similar to A, B and C and not similar to element D. Thus, the AFM provides the benefit of enabling the dynamic source/destination rule creation to be automatically performed based on user selections from the data set instead of manually entering queries. Moreover, when forming a source/destination rule, the module enables a user to combine static data, manually entered dynamic data (e.g. manually entered query), and/or automatically generated static data (e.g. query automatically generated based on user selections) to create the source/destination rule. Alternatively or in addition, the data set itself to be searched is also able to be dynamic and defined by a data set rule that is created in the same manner as the source/destination rules as described herein.

In some embodiments, the generation module enables a user to save and/or name one or more of the source/destination rules/groups (e.g. spendable money rule/group, after tax income rule/group, work deposit rule/group, priority debit rule/group) such that when creating new condition-trigger pairs or modifying existing condition-trigger pairs, the saved rules/groups are able to be accessed a selected for one or more of the conditions/triggers of the condition-trigger pairs (without needing to recreate the rule again).

### Token Generation Module

In some embodiments, the AFM is able to comprise a token generating module or application programming interface that generates a token for depositors or other users to add to or “tag” their transactions with (e.g. as added metadata or other parts of the transaction) such that the AFM is able to detect and use the tokens to automatically identify those deposits as being from that depositor/user (instead of relying on keywords or other identifiers). In some embodiments, instead of or addition to the AFM, the tokens are able to be provided by a third party entity for use with the AFM and or other systems. In such embodiments, the issued tokens are able to be universally unique rather than unique only to the AFM system. In either case, the token used to tag is able to be selected or entered by a user and/or automatically selected by the AFM to identify desired income transaction sources (e.g when creating one or more account rules/plans, source/destination rules and/or generating financial reports). In particular, in this manner each token is able to be used to identify income sources and the associated transactions for providing granularly level budgeting breakdowns to users.

In some embodiments, the module is able to use artificial intelligence (AI), pattern recognition, AI-augmented pattern recognition, or meta-data to search through user transactions for possible income sources that are able to be tagged as an income source. For example, the module is able to monitor transaction source, amount, destination, type (e.g. check, auto-deposit, credit, etc.), frequency, time, day, date and/or other transaction characteristics of an account/user and then automatically identifying individual sources of income based on patterns in these characteristics (e.g. the characteristics/patterns meeting or matching a static or evolving characteristic/pattern value criteria/range of values) and proposing/presenting them to the user in a prompt/message/notification to be approved, discarded, or excluded by the user as needing a particular tag/token. In some embodiments, the module is able to monitor the characteristics of the transactions that are not confirmed by the user (after being prompted) and/or that are explicitly excluded or identified as not being income and adjust the characteristic/pattern value criteria based on the characteristic values/patterns of the excluded transactions.

Thus, if the module determines that for a particular user account a transaction occurs at a particular frequency (e.g. every 7 days), at a particular time in the month (e.g. every 15^{th} and 30^{th} day), and/or for a particular amount (e.g. the same amount each time, between a particular value range or above a threshold value), the module is able to send a notification/prompt to the user on the AFM that asks the user to determine if the transactions or source of the transactions can be tagged as a particular source (e.g. income source). In some embodiments, the prompt is able to be a part of the rule/plan generation process as a supplement to the source selection portion. Alternatively or in addition, module is able to prompt the user to actively search through one or more of the transactions and select one or more of the transactions as needing a tag applied to those transactions.

In some embodiments, the token generation module is able to issue unique identifying tokens externally to banks, credit unions, payment platforms, private businesses, or individual consumers upon request. For example, an AFM issued income token assigned to Joe Adam would allow an AFM user to select Joe as an income source regardless of whether Joe paid him via another entity (e.g. a bank, Zelle, direct deposit, or Paypal), as long as the institutions processing the transactions and associated data were all participating in the use of the AFM tokens in order to identify the transaction/deposit. In some embodiments, the AFM is able to issue a unique token to a platform like PayPal paired with a unique token for the specific user Joe Adam. In such embodiments, for example, both tokens are able to be included within an ACH request to a bank from PayPal wherein the bank would make the tokens associated with the transaction available to 3rd parties that had been authorized access by the account owner (such as data aggregators like Plaid and Yodlee), and the AFM enables a user to create a rule specifying that a particular plan be triggered and/or funded by any payment received from any Paypal user (by identifying sources with the PayPal unique tag), or funded by Joe Adam via PayPal (including the Joe Adam and/or PayPal tags, but excluding payment from Joe Adam via Zelle including a Zelle tag). In some embodiments, this cross-platform token is able to include additional meta-data relevant to the purpose of the transaction, the intended use of the transaction, a particular originating or intermediary account or sub-account, or any other such data intended to communicate unambiguously across various platforms for the purpose of easy, simple, intelligent, and accurate management of finances.

As a result, the AFM enables searching and tagging income for the purpose of identifying a specific depositor and/or identifying income through the use of artificial intelligence (AI), pattern recognition, AI-augmented pattern recognition, or meta-data.

### Performance Module

The performance module automatically performs (e.g. via the servers 102 and/or client devices 104) the plans/rules generated by the user according to the characteristics of the plans/rules as defined by the users when generating the rules/plans. In particular, the performance module begins monitoring the starting triggers of each of the rules once they have been created and then begins performing each of the rules when their duration begins based on the starting trigger and ceases performance when their duration ends based on the ending trigger. Similarly, during the performance of each of the rules, the performance module monitors all of the condition trigger values at the specified intervals and performs the associated actions when one or more of the conditions are satisfied based on the values of the corresponding trigger(s). As a result, the performance module automatically and dynamically performs the AFM plans thereby enabling the users to easily control their financial accounts.

### The Social Module

The social module enables user to specify whether one or more rules (or plans) are public or private, wherein rules specified as private are concealed from view and rules specified as public are able to be viewed by one or more other selected groups/categories users of the AFM (e.g. all users, only users identified as friends, only users selected by the rule creator, or other user groups). If a rule is public, the social module automatically enables one or more other users/accounts on the AFM system to comment on, like, follow (and/or invite to follow), clone and/or become a contributor to the rule (and/or invite to contribute). Alternatively, the social module enables one or more rules to be public, but prevents the rule from being contributed to and/or followed by other users based on selections by the owner of the rule.

Using the cloning function, a user is able to select one or more public rules of other users and the social module automatically creates a duplicate rule for that user (while prompting the user to select parameters that cannot be duplicated such as source accounts that are not controlled by the user). In addition to the values/parameters of the rule, the function is able to duplicate ancillary data about the rule such as a link to the item being saved for, audio/text/video (e.g photos), rule name, goal amount or other data that has been associated with the rule. In some embodiments, the social module enables a user to specify which parts of a public rule are able to be duplicated by another user. Specifically, they are able to specify that current saving amounts or other parameters or values of the rule are hidden or not able to be cloned. For example, if a user selects for cloning a public rule that states “transfer $200 from checking account A to savings account B if balance of checking account is greater than $2000 on the 1^{st} of each month,” the social module automatically creates a duplicate rule and prompts the user to finish the rule by entering accounts “A” and “B” which they control and the user desires to substitute for the parts of the cloned rule that the user does not control (and thus cannot be duplicated).

Using the following function, a user is able to view public rules from other users (e.g. friends) and select one or more of those rules to be followed (if the user who created the rule enabled the following function for the public rule). Once followed, the social module is able to send notifications (e.g. using the notification module) about changes to the status of the rule (e.g. when transactions are made based on the rule, when the rule is edited, if the owner of the rule inputs a message about the rule). For example, a user is able to create a public rule about saving to an account for a vacation to Hawaii that is followed by the parents of the user who then get notifications about deposits into the account (e.g. at one or more user-selected or default account balance milestones), notifications about changes to the amount needed for the rule/vacation, and/or user generated messages about the rule (e.g. “We decided to change plans, now saving for a vacation in Alaska, not Hawaii”). The social module enables a user to select what types or combinations of notifications are sent to which users (e.g. just messages, just milestones, etc.).

Using the contributor function, a user is able to select one or more public rules for which contribution has been enabled by the rule creator and the social module generates a contribution rule that contributes to the selected public rule. For example, if a user has made a public rule about saving to an account for a vacation to Hawaii that is contributed to by the parents of the user, the AFM facilitates the creation of the contribution rule that contributes (based on any specified parameters) to the same Hawaii vacation account in order to help and encourage their child to save for the Hawaii vacation. In some embodiments, the social module automatically creates a generic contribution rule for which the destination of the contribution is the same as the destination of the contributed to rule and prompts the user to edit or add needed parameters (e.g. source account or accounts from which the contribution is to be collected from, trigger-condition pair values, or other parameters of the rule described herein).

In some embodiments, the contribution rule trigger-condition pairs are able to be based on or a function of actions of/changes in status of the contributed rule. For example, a user is able to specify: that the contribution rule contributes an amount that is a factor/ratio (e.g. half, double, 0.25, etc.) of the amount contributed by the contributed to rule; that the contribution rule contributes at the same intervals, different intervals, upon the total contribution by the contributed rule reaching one or more thresholds (e.g. contribute $1000 more when the existing total reaches $1000 to reward for reaching the milestone) and/or a specified relationship to the intervals (e.g. ever other interval) as the contributed rule; that the contribution rule contributes a specified greater or less amount based on the amount contributed by the contributed rule (e.g. contribute an amount such that the sum of the amount contributed by the contributed to rule itself and the contribution rule is equal to $1000); that the contribution rule caps or limits a total amount of contributions made within a period, a total amount of money to be sent in a single transaction, a duration of the contribution rule and/or other limits on the extent of the contributions; and/or that any of the condition trigger pairs of the contribution rule are based on values of the contributed rule in any combination. In some embodiments, like the following function, the contribution function is able to provide notifications to the contributor users about updates/changes to the contributed rule and/or messages from the contributed to user. In some embodiments, the social module notifies the owner of the public rule of the newly generated contribution rule and/or requires the owner of the contributed to rule to approve the request by the user to contribute before the contribution rule is enabled.

In any case, the social module provides the benefit of enabling users to follow another user's plan, clone it, or become a contributor, which provides a social aspect to monetary planning that results in more enthusiasm, teamwork and other encouragement for better monetary habits.

### The Notification Module

The notification module enables users to specify whether they would like notifications when one or more of the conditions have been met and sends the notifications based on the user specifications. The notifications are able to be in the form of text messages, emails, voice messages or other types of notification known in the art. For example, one or more of the actions associated with the rules are able to be assigned a notification status, wherein if the status indicates to, the notification module is able to provide notifications before one or more of the actions are performed. As another example, the notification module is able to optionally send notifications to the user based on one or more milestones of a rule being met, such as a savings account reaching the halfway point or a grade point average becoming greater than 3.0.

Additionally, one or more of the notifications are able to include a confirmation feature, wherein the action associated with the notification is able to only be performed by the module if the user confirms that the action should be made in response to the notification. For example, each of the condition-trigger pairs of a rule are able to have different or the same confirmation requirements that must be satisfied before the action associated with the condition-trigger pair (and the rule) is performed by the AFM product. Thus, the notifications are able to be used to ensure unwanted actions are not taken by the AFM product without user confirmation. Indeed, in some embodiments when a funding account holder receives a notification including a confirmation feature for manual approval on a pending transfer (e.g. as a result of the conditions of a rule being met), the user has the option to log in and approve the scheduled amount or manually enter an alternative dollar amount to be released instead (e.g. manually overriding the transfer amount). The user is able to also have the option to cancel any individual transfer that is awaiting his/her confirmation. The notification module is further able to send the notifications to one or more parties other than the user (wherein the other party's contact information has been input to the AFM product). For example, both users of a transfer between two users are able to receive notifications as desired.

### The Rule/Plan Editing Module

The rule/plan editing module enables a user to review one or more of the existing rules associated with the user profile and change any of the selected characteristics of the rule and/or delete the rule. For example, the user is able to add conditions to the rule or rules within a given payment plan, change targets of one or more conditions or other adjustments to the rule(s). Additionally, in some embodiments, when a user finishes the initial set up of a rule establishing a payment plan of money from one or more accounts of the user (“payer”) to another account of a different user or third party (“payee”), the rule editing module enables the payer to either allow the payee to review and edit the details of the rule(s) or instead to save and immediately activate the plan without enabling the payee to edit/confirm the rule(s). In contrast, in some embodiments if a rule establishing a payment plan is created by a user who is the payee, the rule is able to always be submitted to the payer for review and editing or approval. In such embodiments, once a payer has received the rule or rules generated by the payee, the editing module enables the payer to allow or revoke the payee's ability to edit plan details. Additionally, in some embodiments whenever this “allow payee editing” feature of the editing module is enabled, any time one of the users (payer or payee) makes one or more changes to the rule, the rule is passed back and forth between the users until all of the users approve the rule without any new changes. In some embodiments, each time a plan is passed back and forth for approval, a summary of the recent changes by each user is provided for the convenience of the users.

In some embodiments, the rule creation process is able to be bifurcated wherein first one or more goals (that identify total amounts to be saved, accounts to be saved in and/or identification of what is being saved for, but do not require that the full rule be completed) are able to be created and stored, and subsequently one or more of the goals are able to be selected for completion wherein the remainder of the parameters needed for creating the rule are added (e.g. start, end, condition-trigger pairs, source, or other parameters described herein). Specifically, when a goal is selected for completion the AFM automatically creates a partial rule based on the already entered data of the goal and prompts the user for the additional selections/options/input required to complete the rule. As a result, a user is able to generate, store and view goals without knowing exactly how or when they are going to be completed, and then as soon as they do, the user is able to select the goal and easily convert it to a corresponding rule. In some embodiments, one or more pictures, text and/or videos are able to be associated with one or more of the goals and/or rules such that when accessing the goals/rule a user is presented with the pictures, text and/or videos. For example, a user is able to associate a video of surfing with a goal to visit Hawaii such that when they view that goal they are reminded of why it is important to them and incentivized to convert the goal to a rule (or it already is a rule, to reach the total need to meet the goal of the rule).

### The Rule/Plan Prioritization Module

The rule/plan prioritization module enables a user to adjust the order and therefore priority in which each of the rules associated with one or more of the accounts of their user profile are executed. Specifically, based on this order, each of the plans and their sets of rules are able to be evaluated and then executed in order such that the effects of the previous/higher priority rules/plans on the status/value of the associated accounts and target/parameter values of subsequent rules/plans are included in the evaluation and execution of those subsequent rules/plans. Thus, the rule/plan prioritization module enables the users to optionally rearrange the priority/order that the rules are executed. In some embodiments, this priority is assigned by assigning different times and/or dates when each of the rules are to be executed such that rules with earlier times and/or dates are prioritized before those with later times and/or dates. In such embodiments, if two or more rules are scheduled to execute at the same time, the module is able to prompt the user to assign a priority (e.g. time difference) between the two or more rules until all of the rules are ordered.

### The Virtual Savings Bin Module

The virtual savings bin module enables a user to create savings bins or mini-accounts that are maintained and tracked by the AFM product. These bins are virtual accounts that freeze and control the money within them on behalf of a plan or goal. While the funds within each virtual savings bin are co-mingled in a giant aggregate account, contents of each of the virtual savings bins are not counted in any other balances. Thus, the bins are operated to prevent the money associated within them from being transferred from the aggregate account unless that bin (not the aggregate account) is selected as the source of the transfer.

In some embodiments, the savings bin module is able to generate virtual folders of money that will be tracked separately from the rest of the user's moneys held within one or more of the accounts associated with their user profile. These savings bins are able to represent an identified subset of the money in one or more of the accounts, wherein the subset is specified by the user when generating the savings bin with the savings bin module. In some embodiments, the subset is able to be money transferred into one of the accounts as a result of one or more of the rules. Alternatively, the subset is able to be money transferred into one of the accounts by one or more rules and/or any other types of deposits from one or more of the accounts such as those types/amounts of the targets as described above (e.g. checks above $100, account transfers during a specified time period, all deposits).

For example, a user is able to set up a savings bin that tracks an amount of money transferred into an associated account based on a rule for saving money each month. As a result, even if the account has a total balance of $100, if $25 of that balance is money transferred based on the rule associated with the savings bin, the savings bin balance will be $25. In particular, this enables a user to easily track how much they have saved for a desired item (e.g. a purse) by creating a purse savings bin associated with a rule that periodically saves money for the purpose. Once set up, the module is able to enable the user to use the savings bin as a funding account or a receiving account just like any other account. Additionally, all moneys in savings bins are able to be available for immediate transfer to any other system users, and/or a user is able to delete savings bins.

### The Account Grouping Module

The account grouping module enables users to create account groups that enable the users to use two or more accounts as a single account within the AFM product. In other words, grouping accounts essentially creates a combined account that is presented to the user within the AFM product such that the combined account represents an aggregation of the deposits and debits of all the accounts that are a part of the combined account. In particular, this is able to provide an ease of use, for example, if a user utilizes multiple different accounts for savings and would like to view their savings as a whole across all or a plurality of the accounts instead of individually. Further, once created, a user is able to use the combined account as if it is a regular single account. For example, a user is able to deposit/withdraw money into/out of the combined account as if it was a single account, utilize the rule generation module to generate rules utilizing the combined account as a source or destination account, and/or any of the other features described herein with respect to the accounts.

In order to generate a combined account, the user specifies a plurality of the accounts associated with the user profile that are to make up the combined account and then selects funding and withdrawal policies that define how deposited money is distributed into the accounts of the combined account and/or how withdrawn/transferred money is divided between the balances of the accounts of the combined account. In particular, the withdrawal policies are able to address situations where one or more of the associated accounts have insufficient funds to cover a transfer out of the combined account. In some embodiments, the deposit and/or withdrawal division is able to be percentage based where each of the associated accounts receives and/or contributes an amount based on a percentage assigned to the associated account by the user. In some embodiments, the deposit and/or withdrawal division is able to be proportional to the balance of each of the accounts with response to the whole combined account as dynamically determined each time before the funding/draining occurs.

In other words, if an account makes up half of the entire balance of the combined account, it is drained/funded for half of the entire funding/withdrawal amount. Alternatively, the associated accounts are able to be ordered such that the associated accounts are drained and/or funded based on the order as specified by the user. In such embodiments, the switching to the next account within the order is able to be triggered based on one or more switching thresholds being met. For example, each of the associated accounts is able to be associated with a value, a percentage or both such that once the funding or draining of the account has reached the value, the percentage increase/decrease, or a percentage increase/decrease plus or minus the value, the funding or draining switches to the next account within the order. Further, in some embodiments if the end of the order is reached, the remainder of the funding/draining is performed by withdrawing as much as is needed from the last account, regardless of its individual policies, moving back up to the start of the order if needed to drain all that is required to fulfill the transfer from each account in order of priority or once the last account has been drained according to its policies, the module switches back to the start of the order to drain all that is needed from each account in order of priority regardless of their individual policies until the transfer amount has been satisfied. In some embodiments, when defining policies while forming an account group, a user is able to determine whether or not the individual policies for any individual account within the group are “preferred,” or able to be overridden in cases such as those described above, or whether the policies are absolute such that they are never to be violated.

Additionally, in some embodiments the policies are able to specify how to handle the case where one or more of the accounts have insufficient funds to meet the amount of their share of a withdrawal (as determined by the withdrawal policy and thresholds for those accounts). For example, the policy is able to specify that if one or more of the accounts in a combined account has insufficient funds: cancel the whole transfer (do not transfer money from any account in the group); cancel those accounts' portions/shares of the transfer and send the withdrawal amount from the remaining accounts of the combined account with sufficient funds; send as much as possible from each of those accounts and then send the remaining withdrawal amount from the remaining accounts of the combined account; set up a linear insufficient funds priority/order to use one account to pick up all insufficient funds, then a second if the first falls short, a third, and so on as the user desires (wherein if there are not enough funds in the last account to cover the difference, all available money will be sent from all actively funding accounts in the group) or distribute the difference equally between the other funding accounts, paying as much from all accounts as possible if there's not enough to fund the whole amount with equal portions. Additionally, in some embodiments if two or more accounts have insufficient funds, or if one or more of the “overflow accounts” has insufficient funds to cover the whole amount of the difference from the account(s) with insufficient funds, as much as possible is able to be transferred from each account and the remaining balance owed is able to continue to be covered equally among any accounts in the account group with remaining funds.

Further, in some embodiments, the policies are able to specify an account buffer amount for one or more of the accounts making up the combined account or the combined account as a whole. Thus, if the user selects an option to “protect a certain balance across this combined account” and enters $100 as the protected balance, the distribution of funding and/or draining in combined account proceeds normally, but only after $100 is reserved proportionally over all accounts before performing any funding and/or draining operations. For example, if the combined account was scheduled to transfer $1000 and the accounts have balances of Account A: $750, Account B: $150, and Account C: $100, with the combined account funding method set to “pay automatically/proportionally,” first the protected $100 would be set aside according to the user's “safety buffer” before any calculations are made or transfers sent. The module presumes that Account A has $675 available ($750-$75), Account B has $135 ($150-$15), and Account C has $90 ($100-$10). As a result, the schedules transfer would result in sending $900 in total leaving Account A with $75, Account B with $15, and Account C with $10. In other words, this combined account would always pay as much as possible without dipping into the account buffers. Indeed, in the above case, both the payee and the payer are able to receive a notification that less funds were sent than were scheduled, but that as much was paid as possible according to the policy. In some embodiments, only the payer would be able to see the details of why less funds were sent: that the system was preserving his/her $100 combined account buffer.

Finally, in some embodiments, if a user wishes to use certain accounts in a combined account only to inform conditional rules in certain plans, but does not want to use them for that combined account's funding distribution, the module provides the option to disable those accounts from active funding in that combined account by enabling “reference only” for that account in the smart combined account's settings. This option enables a user to select accounts to be included whenever the system references the combined account's balance or income (as in evaluating a conditional rule), but omit it when the combined account is funding a payment or transfer. It should be noted that all of these options described above are able to be input by a user into the account grouping module and then automatically enforced by the grouping module for the combined accounts.

### The Review Module

The review module enables users to review different types of data about the accounts associated with their user profile. Specifically, the review module illustrates incoming and outgoing histories where a user is able to see all transfers that have come in and gone out over time, expand details where a user is able to expand any transaction to see what conditions and settings were triggered in determining transfer amounts, and provide totals where a user is able to see the total cumulative amounts transferred for any plan and how much is still left to pay or save on it. Further, in some embodiments the review module enables the user to hover over any of the rules to see their projected transfer amount according to the current or predicted values of the associated targets/parameter values associated with the rules and the entered priority. In some embodiments, the review module enables a user to choose to “Add an Expected/Adjustment Deposit to the Timeline,” wherein when the user chooses this option, he/she selects the account receiving the deposit and enters an expected deposit amount and expected clearing date. Based on this input (which is able to appear in a different color on the timeline), the review module displays data indicating how payment and plan transfer amounts would change with various account balances or incomes on certain dates. Specifically, after an expected deposit is entered on the timeline, all plans and payments coming after it would show both a “projected transfer amount with current account conditions” and an additional “projected transfer amount with adjusted account conditions.”

In some embodiments, the review module enables the user to toggle on or off a setting to “include expected/adjustment deposits in the timeline” according to his/her preference, wherein: (1) if toggled off, expected/adjustment deposits disappear from the timeline and “projected transfer amounts with adjusted account conditions” are removed from payment and plan displays; and (2) If toggled on, the expected deposits are included on the timeline once again and both “projected transfer amounts with current account conditions” and “projected transfer amounts with adjusted account conditions” are shown. Also, the review module enables the user to “verify” his/her account plans by evaluating a selected rule associated with the account and bring the user's attention to potential common errors. For example if a user has one account plan rule that pays $100 if his/her balance is less than $2000 and another rule that pays $200 if his/her balance is over $2001, the verification script will ask him/her if he/she intentionally left a gap in the rules between $2000 and $2001 and the user will have the option to automatically resolve the gap by adjusting one or the other of the rules. If the user chooses to automatically resolve the gap by fixing the first rule, that rule will change to pay $100 if the balance is less than $2001.01 (or less than or equal to $2001). If the user chooses to resolve the gap by choosing to fix the second rule, the rule would be resolved in a similar fashion by paying $200 if the user's balance is more than $1999.99 (or more than or equal to $2000). Thus, the review module helps ensure that fully effective rules for each account plan are generated.

### The Product Purchase Module

The product purchase module enables a user to select a product/service from a merchant (e.g. a merchant website) and associated the product with a rule that will automatically (or upon approval) input the necessary information and transmit the necessary money to purchase the selected product/service if the conditions of the rule are met. In particular, such a product purchase rule is similar to a rule for saving money as described herein except that one of the targets/parameters is the price of the product/service and the action is the purchase of the product/service in addition to the transfer of money for the purpose of savings. For example, the rule is able to be conditioned on the price of the item/service (e.g. including shipping, taxes and/or other fees) being within a specified range. Thus, if the price is within that range and other conditions are met (e.g. the funds saved by the rule being equal or greater that price, the current date being within a specified range, or other types of conditions described herein), the product purchase module will either automatically purchase the product/service or will ask the user for confirmation for the purchase and then purchase or not based on the response to the confirmation.

### The Integrated Advertisement Module

The integrated advertisement module enables the AFM product to determine the financial behavior of one or more of the users and integrate advertisement content into the graphical user interface of the product for those users. Specifically, the advertisement module monitors and determines each user's financial behavior data by determining one or more of their financial actions with the product and/or data submitted by each user or received/collected from third party devices/locations (e.g. websites, servers, computers). For example, when the user of an account begins to create a new rule, and in doing so, inputs a name for the rule, selects from a list of rule categories (e.g. vacation savings; tax withholdings) and/or submits data about and/or a link to an item to purchase (e.g. new television savings; link to item on merchant website), the advertisement module is able to identify, parse and/or otherwise isolate the financial behavior data of the user and associate it and the subject it pertains to (e.g. academics; taxes, travel) with the user account. Similarly, when the user is selecting/inputting source/destination accounts (e.g. employer; life insurer; internet provider) and/or triggers for a condition pair (e.g. stock A increases 10%), the module is able to identify the financial behavior data and the subject it relates to for association with the user account.

The financial behavior data is able to be monitored, sampled and/or derived from any of the data input into and/or network-accessible by the AFM product as it operates on/with the AFM server 102, the client device 104 and/or the third party server 106. For example, the financial behavior data is able to be user-selected/submitted items and/or services and their metadata (e.g. items/services submitted using the purchase module and/or their product data either submitted or accessed over the network from a third party source); user submitted text, audio, images and or video (e.g. plan/rule names submitted using the rule creation, editing, review modules; user account data submitted using the registration module; data associated with rules/plans that are followed or contributed to by the user account); user selected condition pair triggers (e.g. grades, sport events, stocks and/or metadata describing those events/activities); entities that interact with the user account (e.g. entities associated with tokens generated by the token module for the account; and/or entities identified as sources and/or destination accounts for one or more rules, withdrawals and/or deposits into user accounts and/or metadata describing those entities).

The advertisement module is then able to use the financial behavior data to select and display advertisement content to that user on the AFM product (e.g. integrated into the graphical user interface of the AFM product). This advertisement content is able to comprise text, images, audio, video, links, scripts, other content and/or combinations thereof. For example, in some embodiments the advertisement content is able to include third party advertisements (e.g. from third party ad servers) and/or internal services, promotions or advertisements from the AFM server 102. In some embodiments, upon selection of an internal service, promotion or advertisement, the AFM product is able to send and email, text message or other communication to the user regarding the advertisement, server or promotion using the account data for the user on the AFM. Further, in some embodiments the advertisement content is able to include embedded offers (e.g. buy now, pay later offers for one or more internal or external products and/or services) and/or virtual/physical card issuance offers (e.g. for purchasing a selected item/service). For example, upon creating a goal/rule for purchasing a television, the AFM is able to select and present a virtual/physical card issuance offer that upon selection issues a card that can be used to purchase the television and the card balance subsequently paid off using the rule/goal via the AFM product.

In some embodiments, the advertisement content is able to include internal or external lending/payment products and services. For example, a user whose savings has exceeded a predefined amount as monitored by the advertisement module is able to be presented a credit card offer that the user is qualified for based on their amount of savings and/or income/spending behavior (e.g. over a predefined time period). As another example, a user whose income exceeds a predetermined amount and/or who saves a predetermined percentage of their income each month (as monitored by the advertisement module) is able to be presented offers for different internal or external features (e.g. tax services; higher limit credit cards; investment opportunities; instant payment features; loan opportunities and/or other financial features offered by the AFM itself, an associated bank, or a third party entity/server). Thus, the advertisement module provides the benefit of being able to reward AFM product users for their financial behavior with the product (e.g. income, debt levels, savings, spending, account balance, quantity of active rules, auto-debit use, and/or the history thereof) by presenting special offers/content to the qualified users based on that behavior.

In some embodiments, the advertisement content is able to include promotions, offers and/or services tied to the goals/rules themselves. Specifically, the offers are able to include savings matching/contribution offers for a rule wherein a static or dynamic value (e.g. 1% of each contribution; the last $100 needed to meet goal/milestone/item amount) is added to an account associated with the rule by the AFM and/or a third party upon acceptance of the offer. For example, the AFM is able to provide offers from a third party bike entity that upon acceptance of the offer by the user, a savings rule for purchasing a bike is created by the AFM and the sale price of the bike is discounted 10% and/or a rebate of a set amount is transferred back into the account upon saving the sale price and purchasing the bike). In some embodiments, the savings rule has one or more set conditions/parameters (as defined by the offer) and/or one or more editable conditions/parameters that the user is able to adjust. In any case, the use of this type of advertisement content provides the advantage of incentivizing savings and/or further use of the AFM product.

In some embodiments, the module stores the financial behavior data identified for each user in a user behavior table (stored on the AFM server 102 and/or locally on the client device 104) that associates the user account and/or user identifier(s) with the current behavior data of that user. This stored financial behavior data is able to be updated by the advertisement module (e.g. periodically, whenever new behavior data is monitored, whenever existing behavior data changes, and/or upon request by the user or an administrator).

In some embodiments, the advertisement module identifies some or all of the financial behavior data by parsing textual data input or selected by the user on the AFM product (e.g. rule/plan/goal input names; purchase module selected items/services; selected rule categories; selected source/destination accounts; selected triggers). Alternatively or in addition, the advertisement module identifies some or all of the financial behavior data by identifying known entities associated with the user account (e.g. entities corresponding to tokens attached to source/destination accounts of rules of the user account; types/identities of triggers selected for rules of the user account; identities of source/destination accounts of rules of the user account).

In operation, when determining advertisement content to display to a user, the advertisement module identifies the financial behavior data of the user account (e.g. as stored in the behavior table), accesses an advertisement content database and determines one or more of the ads on the database that are associated with the financial behavior data of the user account. For example, the module is able to determine which of the ads are associated with words/metadata that match behavior data keywords parsed from the behavior data by the module and select one or more ads from those having matching words/metadata. Alternatively or in addition, the module is able to determine the entities, products and/or services identified by or associated with the user account and determine which of the ads have metadata/words that match or correspond to those entities, products and/or services. In some embodiments, the ad content database including the selected set of ads is stored on the AFM server 102. Alternatively, some or all of the ad content database is able to be stored on the AFM server 102, locally on the client devices 104, on third party servers 106 (e.g. ad servers), other network accessible locations, and/or a combination thereof.

In some embodiments, the financial behavior data used to search the advertisement content database is limited to the subset of the data that corresponds to a particular rule, function or user interface screen of the AFM product where the ad is to be displayed. For example, if the advertisement content is to be displayed on rule related screen/function (e.g. rule creation, rule editing, rule review, rule following, rule contribution) of the user interface, the module is able to only search the advertisement content database using financial behavior data derived/determined from that rule. This is able to include, but is not limited to, the name of the rule/plan/goal, the identities of the source/destination accounts of the rule, the triggers of the rule and/or any other behavior data determined from the rule. Thus, for a rule/plan named “vacation fund,” the module is able to limit the matching search to the keyword “vacation” derived from the name. Similarly, for a plan with a destination account associated with an exercise gym entity, the module is able to limit the matching search to the name of the entity and/or the keywords describing the entity (e.g. exercise, gym). In any case, upon determining the matching subset of the ads, the module selects one or more of the subset and presents those ads to user on the AFM product.

The module is able to display the selected ads within one or more of the graphical user interface screens, features and/or webpages of the AFM product. For example, the module is able to integrate the selected ad content into the login and registration module interface/screen/page, the account module interface/screen/page, the rule/plan editing module interface/screen/page, the rule generation module interface/screen/page, the group identification module interface/screen/page, the token generation module interface/screen/page, the social module interface/screen/page, the notification module interface/screen/page, the rule prioritization module interface/screen/page, the review module interface/screen/page, the account grouping module interface/screen/page, the product purchase module interface/screen/page and/or the virtual savings bin module interface/screen/page. Further, as described above, the integrated advertisement module is able to select where the ad content is to be displayed based on where the financial behavior data used to select the ad content was derived from and/or relates to. For example, if the behavior data was derived from the name of a plan/rule, the integrated advertisement module is able to select the page/screen showing the status or enabling the editing of that rule as the location where the ad content is displayed. Alternatively or in addition, the advertisement module is able to display the selected ad content in any of screens/features of the AFM product independent of where the behavior data used to select the ad content was located. As a result, the integrated advertisement module provides the benefit of enabling the AFM product to display ads that correspond to the financial behavior data of the user accounts.

### Method of Operation

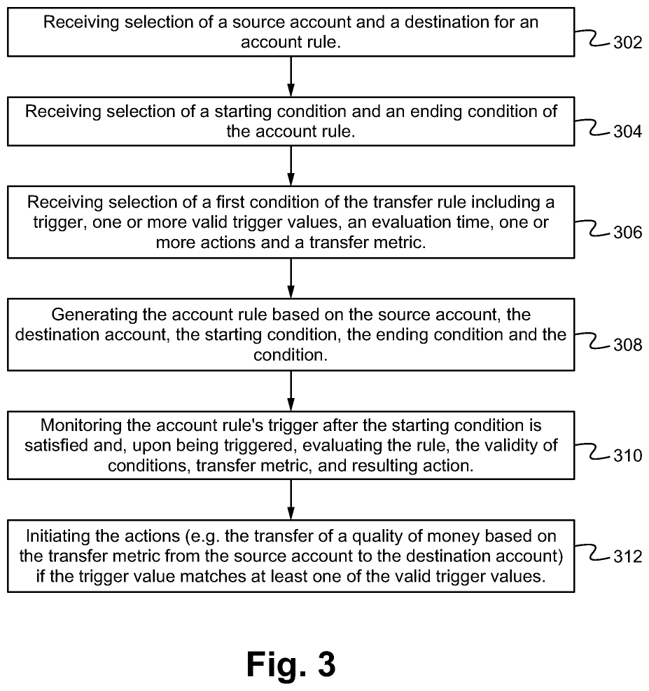

FIG. 3 illustrates a method of dynamic financial management of one or more of monetary accounts according to some embodiments. As shown in FIG. 3, the AFM product inputs selection of a source account and a destination account for an account rule/plan by a user. The AFM product then inputs selection of a starting condition and an ending condition of the account rule by the user at the step 304. The AFM product inputs selection of a condition of the transfer rule including a trigger, one or more valid trigger values, an evaluation time, one or more actions and a transfer metric or equation by the user at the step 306. Alternatively, the AFM product is able to input a plurality of conditions and their associated values from the user for the account rule/plan. In some embodiments, one or more of the input selections are able to be omitted and instead the AFM product is able to provide predetermined default values. Based on the source account, the destination account, the starting condition, the ending condition and the condition, the AFM product generates and stores the account rule/plan at the step 308. The AFM product monitors the trigger of the account rule once the starting condition is satisfied, and upon being triggered to evaluate (based on the evaluation time(s) indicated by the interval/frequency), evaluating the rule by determining the validity of the conditions of the rule and determining an action and a transfer amount (based on the associated transfer amount metric) of the valid one of the conditions at the step 310.

In some embodiments, a primary condition is satisfied by default at each of the evaluation times such that the evaluating of the rule comprises determining if any exception conditions are satisfied thereby overriding the primary condition. Finally, the AFM product initiates the action associated with the condition (e.g. transfer of a quantity of money based on the transfer metric from the source account to the destination account) if the trigger value (or monitored variable) matches at least one of the valid trigger values such that the condition is met. In some embodiments, if the rule includes a plurality of conditions associated with the same action, the action is only initiated if all of the conditions are met. In some embodiments, if the rule includes a plurality of conditions associated with different actions, the different actions are each initiated if their associated conditions are all met. In some embodiments, the AFM product then pauses or terminates the account rule when the ending condition has been met. Alternatively, the ending condition is able to be omitted and/or indicate indefinite operation of the rule/plan. As a result, the method provides the advantage of enabling a user to easily automatically manage their financial accounts according to a plurality of selected scenarios.

In some embodiments, the method further comprises receiving selection by the user of a confirmation preference for the rule (e.g. whether a confirmation notification is required before an action should take place), wherein the AFM product then refrains from the initiating of the action until the confirmation preference has been met for the rule. In some embodiments, the method further comprises presenting a notification of the calculated amount of money to be transferred based on the rule or rules of the plan such that the user is able to evaluate whether the rule is going to do what they want it to accomplish or whether they would like to cancel or amend the transfer for any personal reason. In some embodiments, the method further comprises presenting to the user a total amount of money that has been transferred based on the rule such that the user is able to evaluate whether the rule is doing what they want the rule to accomplish. In other words, the user is able to be presented with “historical” data indicating how much, when and where money has been transferred because of the rule or rules in a given time period in order to determine the effects of the rule or rules in that time period. In some embodiments, the method further comprises receiving selection by the user of a product/service from a third party website having a projected cost, creating a savings bin for the product and automatically purchasing the product/service from the third party website if an amount of money within the virtual savings bin equals the projected cost. In some embodiments, the method further comprises receiving selection by the user of a spending limit for the rule associated with the product, wherein the AFM refrains from purchasing the product/service or shopping cart of products, services, taxes, and/or shipping fees if the total amount of money transferred based on the rule equals the spending limit. In some embodiments, the source and/or destination accounts are combined accounts that represent a plurality of accounts that are funded and drained according to funding and draining policies. Additionally, although the method of FIG. 3 includes steps 302-310, one or more of the steps are able to be omitted, rearranged and/or additional steps are able to be added including one or more of the features described herein.

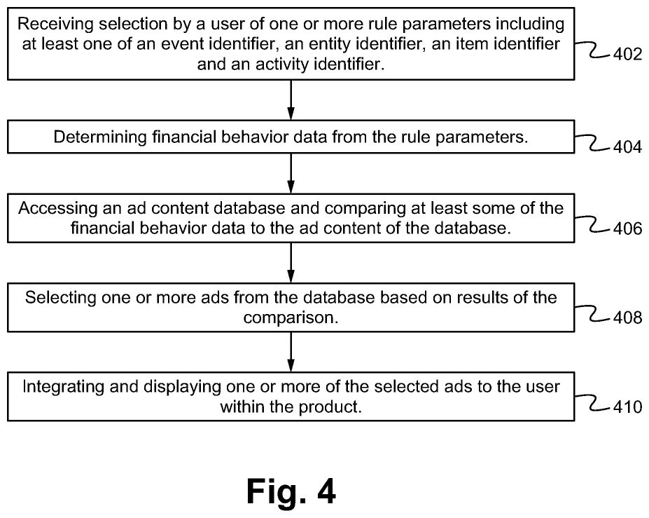

FIG. 4 illustrates of method of dynamic financial management of monetary accounts including an integrated advertisement function according to some embodiments. As shown in FIG. 4, the AFM product, receives selection by a user of one or more rule parameters including at least one of an event identifier (e.g. stock A drops below value X), an entity identifier (e.g. source account), an item identifier (e.g. item URL; description) and an activity identifier (e.g. activity URL; description) at the step 402. The AFM product derives financial behavior data from the rule parameters at the step 404. In some embodiments, the product derives the financial behavior data by determining the names, internet addresses and/or other information about the items/entities indicated by the submitted identifiers and/or parsing some or all of text/images/audio submitted for keywords. In some embodiments, the AFM product associates the determined financial behavior data with the user account in an account advertisement content association table. The AFM product accesses an ad content database and compares at least some of the financial behavior data to the ad content of the database at the step 406. In some embodiments, the comparing comprising searching for keywords and/or the entity names/data within the metadata associated with the ads on the ad content database and selecting a subset of the ads that include the most or closest matches. The AFM product selects one or more ads from the database based on results of the comparison at the step 408. The AFM product integrates and displays one or more of the selected ads to the user within the product at the step 410. In some embodiments, the location of where the ads are displayed/integrated within the AFM product is based on where the financial data used to select the ads was located within the product. Thus, the AFM product provides the advantage of enabling ad content relating to financial behavior to be selected and presented to user accounts on the product.

In some embodiments, the graphical user interface of the AFM product enables the user to identify the goal/rule parameters by manually entering text into a text receiving feature of the user interface. In some embodiments, selecting the set of advertisement content comprises parsing one or more words from the text and comparing the parsed words to words associated with ads of the ad content database. In some embodiments, the graphical user interface of the product enables the user to identify the goal/rule parameters by selecting the at least one identifiers from a list of a plurality of predetermined identifiers of the product. In some embodiments, the graphical user interface of the AFM product enables the user to identify the goal/rule parameters by inputting a web address to a web page including the item identified by the item identifier. In some embodiments, at least a portion of the set of advertisement content is selected by the AFM product based on the other goal/rule parameters of the another goal/rule followed by or contributed to by the user account.

### Advantages

Thus, the AFM system 100 described herein has numerous advantages. Specifically, the system provides the advantage of allowing users to move money according to various scheduled rules, thus allowing users at large to fully control their moneys, incomes, and payments based on highly customizable rules. Further, the AFM interface provides the advantage of a streamlined process that breaks down each of the features of the product into a few easy steps. Indeed, each of the modules of the AFM product provide unique features such as combined accounts, personalized rule generation, and other features described herein that together provide the advantage of enabling users to setup dynamic financial management rules that adjust to different scenarios in the same way a person would instead of static auto payments. Further, the AFM provides the advantage of the ability to create and maintain active payment and savings plans which operate contingent on the individual's personal financial circumstances. The AFM allows users to create financial management plans that wait until a user's specified conditions exist before executing transfers of funds. It further allows the users to transfer more aggressively when conditions are particularly favorable, for example, paying off debts as soon as possible when there are enough funds to cover basic necessities. The AFM allows users to create unlimited active plans for any imaginable goal, regardless of their employment status or net worth. For example, in a society where many people have multiple jobs and thus a more chaotic finance situation to manage, the AFT enables users to create income tax withholding plans for only certain income streams (i.e. taxable streams that have not already had tax withholding applied or are exempt). This is in particular a major boon to the “gig” economy where there is no automated tax withholding solution that fits to user's bank accounts.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims. Exemplary implementations of the AFM product are described in U.S. patent Ser. No. 16/428,848, filed May 31, 2019, and entitled “A DYNAMIC FINANCIAL MANAGEMENT SYSTEM, METHOD AND DEVICE,” which is hereby incorporated by reference.

1. A method of dynamic financial management of one or more of monetary accounts, the method comprising:
receiving, at a financial management server, selection by a user of one or more goal parameters of a goal, the goal parameters including at least one of data identifying an item and data identifying an activity and selecting a set of advertisement content based on the at least one of the data identifying the item and the data identifying the activity with the financial management server;
receiving, at the financial management server, selection by the user of one of the monetary accounts as a source account for an account rule corresponding to the goal and selection of another of the monetary accounts as a destination account for the account rule;
receiving, at the financial management server, selection by the user of a primary condition of the account rule, the primary condition comprising a primary transfer amount metric including at least one of a static value and a percentage, wherein the metric defines a primary quantity of money from the source account that is to be transferred to the destination account if the primary condition is met;
generating the account rule based on the source account, the destination account and the primary condition;
providing, with the financial management server, a rule contribution function that enables the user to select another account rule of another user, wherein the another account rule corresponds to another goal of the another user having other goal parameters;
automatically generating, with the financial management server, a contribution rule for the user, the contribution rule having a same destination account as the selected another account rule such that the user is able to contribute to the another account rule;
selecting, with the financial management server, at least a portion of the set of advertisement content based on the other goal parameters of the another goal corresponding to the another account rule of the other user; and
presenting on a user device, with the financial management server, status information about the account rule corresponding to the goal in conjunction with the set of advertisement content selected based on the goal parameters.

2. The method of claim 1, further comprising providing a graphical user interface, with the financial management server, wherein the graphical user interface enables the user to identify the one or more goal parameters by manually entering text into a text receiving feature of the graphical user interface.

3. The method of claim 2, wherein selecting the set of advertisement content comprises parsing one or more words from the text and comparing the parsed words to words associated with ads of a database of ads including the set of advertisement content.

4. The method of claim 1, further comprising providing a graphical user interface, with the financial management server, wherein the graphical user interface enables the user to identify the one or more goal parameters by selecting the at least one of the data identifying the item and the data identifying the activity from a list of data identifying a plurality of predetermined items and activities.

5. The method of claim 1, further comprising providing a graphical user interface, with the financial management server, wherein the graphical user interface enables the user to identify the one or more goal parameters by inputting a web address to a web page including the item identified by the item identifier.

6. The method of claim 1, wherein the monetary accounts are associated with a user account of the user, further comprising selecting, with the financial management server, at least a portion of the set of advertisement content based on at least one of: one or more types of one or more of the monetary accounts and identities of one or more entities associated with the one or more of the monetary accounts.

7. The method of claim 1, further comprising:
providing, with the financial management server, a rule following function that enables the user to select another account rule of another user and receive notifications indicating changes in status of the another account rule, wherein the another account rule corresponds to another goal of the another user having other goal parameters; and
selecting, with the financial management server, at least a portion of the set of advertisement content based on the other goal parameters of the another goal corresponding to the another account rule of the other user.

8. (canceled)

9. The method of claim 1, wherein the advertisement content comprises hyperlinks to network accessible locations associated with the advertisement content.

10. A dynamic financial management server for the management of one or more of monetary accounts, the server comprising:
a processor; and
a non-transitory computer-readable medium storing a financial management product and communicatively coupled with the servers over one or more networks, wherein when executed by the processor the financial management product is operable to:
receive selection by a user of one or more goal parameters of a goal, the goal parameters including at least one of data identifying an item and data identifying an activity and select a set of advertisement content based on the at least one of the data identifying the item and the data identifying the activity;
receive selection by the user of one of the monetary accounts as a source account for an account rule corresponding to the goal and selection of another of the monetary accounts as a destination account for the account rule;
receive selection by the user of a primary condition of the account rule, the primary condition comprising a primary transfer amount metric including at least one of a static value and a percentage, wherein the metric defines a primary quantity of money from the source account that is to be transferred to the destination account if the primary condition is met; and
store the account rule on the non-transitory computer-readable medium, wherein the account rule is based on the source account, the destination account and the primary condition;
provide a rule contribution function that enables the user to select another account rule of another user, wherein the another account rule corresponds to another goal of the another user having other goal parameters;
automatically generate a contribution rule for the user, the contribution rule having a same destination account as the selected another account rule such that the user is able to contribute to the another account rule;
select at least a portion of the set of advertisement content based on the other goal parameters of the another goal corresponding to the another account rule of the other user; and
present status information about the account rule corresponding to the goal in conjunction with the set of advertisement content selected based on the goal parameters.

11. The server of claim 10, wherein when executed by the processor the financial management product is operable to provide a graphical user interface, wherein the graphical user interface enables the user to identify the one or more goal parameters by manually entering text into a text receiving feature of the graphical user interface.

12. The server of claim 11, wherein selecting the set of advertisement content comprises parsing one or more words from the text and comparing the parsed words to words associated with ads of a database of ads including the set of advertisement content.

13. The server of claim 10, wherein when executed by the processor the financial management product is operable to provide a graphical user interface, wherein the graphical user interface enables the user to identify the one or more goal parameters by selecting the at least one of the data identifying the item and the data identifying the activity from a list of data identifying a plurality of predetermined items and activities.

14. The server of claim 10, wherein when executed by the processor the financial management product is operable to provide a graphical user interface, wherein the graphical user interface enables the user to identify the one or more goal parameters by inputting a web address to a web page including the item identified by the item identifier.

15. The server of claim 10, wherein the monetary accounts are associated with a user account of the user and when executed by the processor the financial management product is operable to select at least a portion of the set of advertisement content based on at least one of: one or more types of one or more of the monetary accounts and identities of one or more entities associated with the one or more of the monetary accounts.

16. The server of claim 10, wherein when executed by the processor the financial management product is operable to:
provide a rule following function that enables the user to select another account rule of another user and receive notifications indicating changes in status of the another account rule, wherein the another account rule corresponds to another goal of the another user having other goal parameters; and
select at least a portion of the set of advertisement content based on the other goal parameters of the another goal corresponding to the another account rule of the other user.

17. (canceled)

18. The server of claim 10, wherein the advertisement content comprises hyperlinks to network accessible locations associated with the advertisement content.

19. A non-transitory computer-readable medium storing a dynamic financial management product for providing dynamic financial management of one or more monetary accounts, wherein when executed by a processor the product performs a method comprising:
receiving, via a user interface of the product, selection by a user of one or more goal parameters of a goal, the goal parameters including at least one of data identifying an item and data identifying an activity and selecting a set of advertisement content based on the at least one of the data identifying the item and the data identifying the activity with the product;
receiving, via the user interface of the product, selection by the user of one of the monetary accounts as a source account for an account rule corresponding to the goal and selection of another of the monetary accounts as a destination account for the account rule;
receiving, via the user interface of the product, selection by the user of a primary condition of the account rule, the primary condition comprising a primary transfer amount metric including at least one of a static value and a percentage, wherein the metric defines a primary quantity of money from the source account that is to be transferred to the destination account if the primary condition is met;
generating the account rule based on the source account, the destination account and the primary condition;
providing a rule contribution function that enables the user to select another account rule of another user, wherein the another account rule corresponds to another goal of the another user having other goal parameters;
automatically generating a contribution rule for the user, the contribution rule having a same destination account as the selected another account rule such that the user is able to contribute to the another account rule;
selecting at least a portion of the set of advertisement content based on the other goal parameters of the another goal corresponding to the another account rule of the other user; and
presenting on a user device, via the user interface of the product, status information about the account rule corresponding to the goal in conjunction with the set of advertisement content selected based on the goal parameters.

20. The medium of claim 19, wherein when executed by a processor the product enables the user to identify the one or more goal parameters by manually entering text into a text receiving feature of the user interface.

21. The medium of claim 20, wherein selecting the set of advertisement content comprises parsing one or more words from the text and comparing the parsed words to words associated with ads of a database of ads including the set of advertisement content.

22. The medium of claim 19, wherein when executed by a processor the product enables, via the user interface of the product, the user to identify the one or more goal parameters by selecting the at least one of the data identifying the item and the data identifying the activity from a list of data identifying a plurality of predetermined items and activities.

23. The medium of claim 19, wherein when executed by a processor the product enables, via the user interface of the product, the user to identify the one or more goal parameters by inputting a web address to a web page including the item identified by the item identifier.

24. The medium of claim 19, wherein the monetary accounts are associated with a user account of the user and when executed by a processor the product selects, with the product, at least a portion of the set of advertisement content based on at least one of: one or more types of one or more of the monetary accounts and identities of one or more entities associated with the one or more of the monetary accounts.

25. The medium of claim 19, wherein when executed by a processor the product:
provides a rule following function that enables the user to select another account rule of another user and receive notifications indicating changes in status of the another account rule, wherein the another account rule corresponds to another goal of the another user having other goal parameters; and
selects at least a portion of the set of advertisement content based on the other goal parameters of the another goal corresponding to the another account rule of the other user.

26. (canceled)

27. The medium of claim 19, wherein the advertisement content comprises hyperlinks to network accessible locations associated with the advertisement content.

28. A financial management device for the management of one or more of monetary accounts, the device comprising:
a processor; and
a non-transitory computer-readable medium storing a dynamic financial management product, wherein when executed by the processor the product performs a method comprising:
receiving, via a user interface of the product, selection by a user of one or more goal parameters of a goal, the goal parameters including at least one of data identifying an item and data identifying an activity and selecting a set of advertisement content based on the at least one of the data identifying the item and the data identifying the activity with the product;
receiving, via the user interface of the product, selection by the user of one of the monetary accounts as a source account for an account rule corresponding to the goal and selection of another of the monetary accounts as a destination account for the account rule;
receiving, via the user interface of the product, selection by the user of a primary condition of the account rule, the primary condition comprising a primary transfer amount metric including at least one of a static value and a percentage, wherein the metric defines a primary quantity of money from the source account that is to be transferred to the destination account if the primary condition is met;
generating the account rule based on the source account, the destination account and the primary condition;
providing a rule contribution function that enables the user to select another account rule of another user, wherein the another account rule corresponds to another goal of the another user having other goal parameters;
automatically generating a contribution rule for the user, the contribution rule having a same destination account as the selected another account rule such that the user is able to contribute to the another account rule;
selecting at least a portion of the set of advertisement content based on the other goal parameters of the another goal corresponding to the another account rule of the other user; and
presenting on the device, via the user interface of the product, status information about the account rule corresponding to the goal in conjunction with the set of advertisement content selected based on the goal parameters.

29. The device of claim 28, wherein when executed by the processor the product enables the user to identify the one or more goal parameters by manually entering text into a text receiving feature of the user interface.

30. The device of claim 29, wherein selecting the set of advertisement content comprises parsing one or more words from the text and comparing the parsed words to words associated with ads of a database of ads including the set of advertisement content.

31. The device of claim 28, wherein when executed by the processor the product enables, via the user interface of the product, the user to identify the one or more goal parameters by selecting the at least one of the data identifying the item and the data identifying the activity from a list of data identifying a plurality of predetermined items and activities.

32. The device of claim 28, wherein when executed by the processor the product enables, via the user interface of the product, the user to identify the one or more goal parameters by inputting a web address to a web page including the item identified by the item identifier.

33. The device of claim 28, wherein the monetary accounts are associated with a user account of the user and when executed by the processor the product selects at least a portion of the set of advertisement content based on at least one of: one or more types of one or more of the monetary accounts and identities of one or more entities associated with the one or more of the monetary accounts.

34. The device of claim 28, wherein when executed by the processor the product:
provides a rule following function that enables the user to select another account rule of another user and receive notifications indicating changes in status of the another account rule, wherein the another account rule corresponds to another goal of the another user having other goal parameters; and
selects at least a portion of the set of advertisement content based on the other goal parameters of the another goal corresponding to the another account rule of the other user.

35. (canceled)

36. The device of claim 28, wherein the advertisement content comprises hyperlinks to network accessible locations associated with the advertisement content.
